(19) United States
(12) Patent Application Publication
(10) Pub. No.: US 2010/0289715 A1
(43) Pub. Date: Nov. 18, 2010

(54) Metamaterial particles having active electronic components and related methods

(75) Inventors: Steven A. Cummer, Chapel Hill, NC (US); Bogdan-Ioan Popa, Durham, NC (US)

Correspondence Address: JENKINS, WILSON, TAYLOR & HUNT, P. A., 3100 Tower Blvd., Suite 1200, DURHAM, NC, 27707, US

(73) Assignee: Duke University

(21) Appl. No.: 12/011,206

(22) Filed: Jan. 24, 2008

Related U.S. Application Data
(60) Provisional application No. 60/898,284, filed on Jan. 30, 2007.

(51) Int. Cl. H01Q 7/08; H01Q 19/06

(52) U.S. Cl. 343/788; 343/911 R

(57) ABSTRACT

Metamaterial particles having active electronic components are disclosed. According to one aspect, a metamaterial particle in accordance with the subject matter disclosed herein can include a field sensing element adapted to sense a first field and adapted to produce a sensed field signal representative of the first field in response to sensing the first field. Further, the metamaterial particle can include an active electronic component adapted to receive the sensed field signal and adapted to produce a drive signal based on the sensed field signal. A field generating element can be adapted to receive the drive signal and adapted to produce a second field based on the drive signal.

### RELATED APPLICATIONS

The presently disclosed subject matter claims the benefit of U.S. Provisional Patent Application Ser. No. 60/898,284, filed Jan. 30, 2007, the disclosure of which is incorporated herein by reference in its entirety.

### GOVERNMENT INTEREST

This presently disclosed subject matter was made with U.S. Government support under Grant No. HR001-05-C-0068 awarded by the Defense Advanced Research Projects Agency (DARPA) of the Department of Defense. Thus, the U.S. Government has certain rights in the presently disclosed subject matter.

### TECHNICAL FIELD

The subject matter disclosed herein generally relates to metamaterials. More particularly, the subject matter disclosed herein relates to metamaterial particles having active electronic components and related methods.

### BACKGROUND

Metamaterials are a new class of ordered composites that exhibit exceptional properties not readily observed in nature. These properties arise from qualitatively new response functions that are not observed in the constituent materials and result from the inclusion of artificially fabricated, extrinsic, low dimensional inhomogeneities, which may be referred to as “metamaterial particles”. These artificial composites can achieve material performance beyond the limitations of conventional composites. To date, most of the scientific activity with regard to metamaterials has centered on their electromagnetic properties.

Metamaterials can be used to engineer electromagnetic properties of a material by embedding numerous small metamaterial particles in a host matrix. These particles can produce an electric or magnetic dipole moment in response to an applied field. Metamaterials have properties that could potentially be used to fabricate super lenses, miniaturized antennas, enhanced tunneling effect devices, and invisibility cloaks. Electric and magnetic metamaterials have been extensively analyzed theoretically, in simulations, and tested experimentally, and are currently built by putting together arrays of passive subwavelength resonant particles, such as split-ring-resonators (SRRs), omega particles, electric-field-coupled resonators (ELCs), and cut-wires.

The currents and charges in these passive, self-resonant circuits created in response to an applied electric or magnetic field near the resonant frequency are great enough to generate electric or magnetic dipole moments that are in turn great enough to substantially alter the effective permittivity or permeability of a medium composed of these particles. However, exploiting this strong response close to resonance usually means significant losses and strongly frequency dependent properties, two consequences undesirable in many potential metamaterial applications. For example, it has been shown both theoretically and experimentally that the smallest amount of loss could significantly influence the effectiveness of the evanescent wave enhancement property responsible for the super lens and enhanced tunneling effects. On the other hand, it has been shown that even modest loss tangents of 0.01 can rarely be achieved in these metamaterials. Also, due to their resonant nature, the inherent high dispersion of current metamaterials makes them useful only for narrow bandwidth applications.

Accordingly, for the reasons set forth above, it is desirable to provide metamaterial particles having reduced loss, lower dispersion, and higher bandwidth.

### SUMMARY

According to one aspect, metamaterial particles having active electronic components are disclosed herein. A metamaterial particle can include a field sensing element adapted to sense a first field and adapted to produce a sensed field signal representative of the first field in response to sensing the first field. Further, the metamaterial particle can include an active electronic component adapted to receive the sensed field signal and adapted to produce a drive signal based on the sensed field signal. A field generating element can be adapted to receive the drive signal and adapted to produce a second field based on the drive signal.

According to another aspect, methods for providing a field in response to sensing another field are disclosed herein. A method in accordance with the subject matter disclosed herein can include providing a metamaterial particle comprising a field sensing element, an active electronic component, and a field generating element. At the field sensing element, a first field can be sensed, and a sensed field signal representative of the first field can be produced. At the active electronic component, the sensed field signal can be received, and a drive signal based on the sensed field signal can be produced. Further, at the field generating element, a second field can be produced based on the drive signal.

### BRIEF DESCRIPTION OF THE DRAWINGS

Preferred embodiments of the subject matter described herein will now be explained with reference to the accompanying drawings of which:

FIG. 1 is a schematic diagram of an exemplary metamaterial particle including an active electronic component and magnetic dipoles in accordance with an embodiment of the subject matter disclosed herein;

FIG. 2 is a schematic diagram of an exemplary metamaterial particle including an active electronic component and electric dipoles in accordance with an embodiment of the subject matter disclosed herein;

FIG. 3 is a schematic diagram of an exemplary metamaterial particle including an active electronic component, a magnetic dipole, and an electric dipole in accordance with an embodiment of the subject matter disclosed herein;

FIG. 4 is a schematic diagram of an exemplary metamaterial particle including an active electronic component, an electric dipole, and a magnetic dipole in accordance with an embodiment of the subject matter disclosed herein;

FIG. 5 is a schematic diagram of an exemplary metamaterial particle including an active electronic component, magnetic dipoles, and field amplifying elements in accordance with the subject matter disclosed herein;

FIG. 6 is a flow chart of an exemplary process for providing a field in response to sensing another field according to an embodiment of the subject matter disclosed herein;

FIG. 7 is a schematic diagram of a metamaterial particle having a field sensing element and a field generating element in accordance with the subject matter disclosed herein;

FIG. 8 is a circuit diagram of the magnetic particle shown in FIG. 6;

FIG. 9 is a graph showing effective permeability versus frequency resulting from an experiment conducted using a metamaterial particle including a 1W1000 amplifier in accordance with the subject matter disclosed herein;

FIG. 10 is a graph showing measured effective permeability versus frequency in experimental results obtained with a metamaterial particle in accordance with the subject matter disclosed herein;

FIG. 11 is a graph showing effective permeability versus frequency resulting from an experiment conducted using a metamaterial particle including a MAX2472 voltage buffer in accordance with the subject matter disclosed herein;

FIG. 12 is a graph showing theoretically achievable effective permeability in a metamaterial particle including an active electronic component in accordance with the subject matter disclosed herein;

FIG. 13 is a graph showing the magnetic susceptibility versus frequency in experiments conducted with a metamaterial particle containing field amplifying elements with the power to the amplifier turned off;

FIG. 14 is a graph showing the complex permeability versus frequency for the same metamaterial particle with the power to the amplifier turned on; and

FIG. 15 is a graph showing the transmission amplitude of a signal passing through an array of metamaterial particles in both directions.

### DETAILED DESCRIPTION

Metamaterial particles are disclosed that employ active electronic components, field sensing elements and field generating elements. These metamaterial particles can overcome the inherent limitations of metamaterial particles employing only passive elements, such as loss, dispersion, and narrow bandwidth. The metamaterial particles described herein can reduce or control with greater flexibility limitations on loss and dispersion.

A metamaterial particle in accordance with the subject matter disclosed herein can include a field sensing element adapted to sense an applied field and adapted to produce a sensed field signal representative of the field in response to sensing the applied field. For example, the field sensing element can sense a magnetic or electric field and produce an electrical signal representative of the sensed field. The representative signal can be proportional to a magnitude and phase of the sensed field. Further, the metamaterial particle can include an active electronic component for receiving the sensed field signal and for producing a drive signal based on the sensed field signal. For example, the active electronic component can be an amplifier operable to produce a drive signal that is a function of the sensed field signal. A field generating element can receive the drive signal and produce another field based on the drive signal. For example, the field generating element can produce a magnetic or electric field in response to receiving the drive signal. Additional embodiments and examples of the metamaterial particles in accordance with the subject matter disclosed herein are provided hereinbelow.

As used herein, the term “active electronic component” refers to an electronic element having gain or directionality. Examples of active electronic components include any suitable semiconductor and any suitable signal or power amplifying component having an external power source such as a transistor, an operational amplifier, a parametric amplifier, a voltage amplifier, and a power amplifier. An active electronic component can be packaged in a discrete form with two or more connecting leads or metallic pads. Further, for example, an active electronic component can include at least one input and at least one output. The active electronic component can receive an input signal at an input terminal and can produce an output signal at its output terminal that is a function of the input signal. A power source can be operably connected to the active electronic component for providing power for input gain. In contrast to an active electronic component, a “passive electronic component” has neither gain nor directionality.

As used herein, the term “field” refers to one of or both a magnetic field and an electric field. A magnetic field is a field that permeates space and which exerts a magnetic force on moving electric charges and magnetic dipoles. Magnetic fields surround electric currents, magnetic dipoles, and changing electric fields. An electric field is a property that can be referred to as the space surrounding an electric charge or in the presence of a time-varying magnetic field.

As used herein, the term “field sensing element” refers to an element operable to sense a magnetic field and/or an electrical field and operable to generate a signal representative of the sensed field. Examples of a field sensing element include a magnetic dipole, such as a metallic loop, and an electric dipole, such as a pair of wires. In one example, in the presence of a magnetic field, a metallic loop can generate a current through the loop. The generated current can indicate the presence of the magnetic field. In another example, in the presence of an electrical field, a wire pair can generate a voltage difference between the wires. The generated voltage difference can indicate the presence of the electrical field.

As used herein, the term “field generating element” refers to an element operable to receive an input signal and operable to generate a magnetic field and/or an electrical field in response to the received input signal. Examples of a field generating element include a magnetic dipole, such as a metallic loop, and an electric dipole, such as a pair of wires. In one example, in response to receiving an input signal, a metallic loop can generate a magnetic field. The input to the metallic loop can be application of a voltage difference between ends of the loop. In another example, a wire pair can generate an electric field in response to receiving an input signal. The input to the wire pair can be application of a voltage difference between the wires. The generated field can be proportional to the input signal.

As used herein, the term “magnetic dipole” refers to a component having a closed circuit of electric current. For example, a magnetic dipole can be a wire loop. Application of current in the wire loop can produce a magnetic dipole moment that points through the loop. Thus, a magnetic field can be generated by application of the current. The magnitude of the magnetic dipole moment is equal to the current in the loop times the area of the loop. Conversely, application of a magnetic field through the loop can generate current in the loop. Therefore, a magnetic dipole can be used for sensing the presence of a magnetic field by detection of generated current.

As used herein, the term “electric dipole” refers to refer to a component having a spatial separation of positive and negative charge. For example, an electric dipole can be a pair of wires that are spatially separated. Application of a voltage difference to the wires can produce an electric dipole moment that points from the negative charge towards the positive charge, and has a magnitude equal to the strength of each charge times the separation between the charges. Conversely, application of an electric field between the wires can generate a voltage. Therefore, an electric dipole can be used for sensing the presence of an electric field by detection of generated voltage difference.

### Examples of Metamaterial Particles

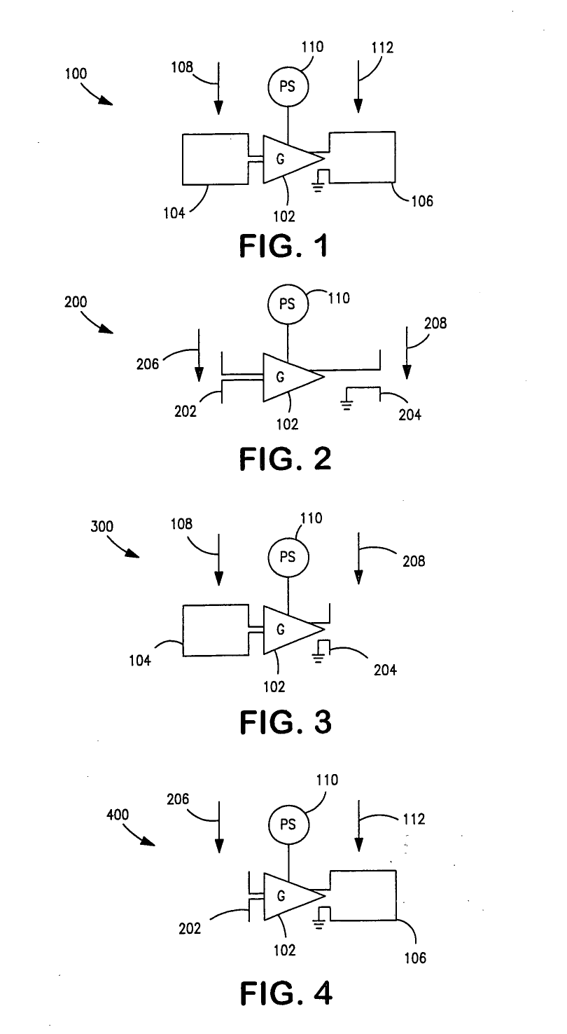

In one embodiment, a metamaterial particle in accordance with the subject matter disclosed herein can include an active electronic component, and a field sensing element and a field generating element in the form of magnetic dipoles. FIG. 1 is a schematic diagram of an exemplary metamaterial particle generally designated 100 including an active electronic component 102 and magnetic dipoles 104 and 106 in accordance with an embodiment of the subject matter disclosed herein. Referring to FIG. 1, magnetic dipole 104 can function as a field sensing element adapted for sensing a magnetic field. Magnetic dipole 104 can sense a magnetic field 108 propagating in the direction of magnetic dipole 104.

In this example, magnetic dipole 104 is a metallic loop sized smaller than the magnetic field wavelength. On application of magnetic field 108 through the loop, a current is produced in the loop that is proportional to the strength of the magnetic field. The produced current results in a voltage difference at the ends of the loop. The voltage difference is referred to herein as a sensed field signal because it represents the sensed magnetic field and can be received by active electronic component 102.

Active electronic component 102 can include an input for receiving the voltage difference present at the ends of the loop of magnetic dipole 104. Particularly, active electronic component 102 can receive as input the voltage difference produced in the loop of magnetic dipole 104. Thus, active electronic component 102 can receive a signal representative of magnetic field 108. In response to receiving the sensed field signal, active electronic component 102 can produce a drive signal that is a function of the received signal. In this example, active electronic component 102 is an amplifier configured to amplify the sensed field signal by gain G and to output a drive signal, which is the sensed field signal multiplied by gain G. Thus, in this example, the output of the active electronic component is the gain G times the input sensed field signal. Alternatively, the output of the active electronic component can be any predetermined function of the input sensed field signal. Active electronic component 102 can be powered by any suitable power source 110.

The predetermined function can include current amplification by a predetermined gain G. Alternatively, the predetermined function can include power amplification. Further, for example, the function can provide the features of a nonlinear device. In a linear active electronic component for example, the function can be represented by the equation Vₒᵤₜ=GVᵢₙ, where Vᵢₙ is the voltage input into the active electronic component, Vₒᵤₜ is the voltage output by the active electronic component, and G is the gain. In a nonlinear active electronic component for example, the function can be represented by the equation Vₒᵤₜ=GVᵢₙ², where Vᵢₙ, is the voltage input into the active electronic component, Vₒᵤₜ is the voltage output by the active electronic component, and G is the gain. An active electronic component may be any suitable function that alters Vₒᵤₜ with the aide of an external power source.

The following equations can apply to active electronic component 102 with regard to gain. An input voltage from magnetic dipole element 104 can be represented by Vₛₑₙₛₑ=jωAₛₑₙₛₑB, wherein B is the propagation constant through transmission lines. The output voltage to magnetic dipole element 106 can be represented by Vₒᵤₜ=jωAₛₑₙₛₑBG. The field produced by magnetic dipole element can be represented by the following equation:

$${m}_{out} = \frac{jω {A}_{sense} BG}{{A}_{driven} {Z}_{driven}}$$

where m is the magnetic moment generated by metamaterial particle, j is the square root of −1 and represents a 90 degree phase shift, ω is 2π* the signal frequency, B is the input magnetic field strength, Aₛₑₙₛₑ is the area enclosed by the sensing loop, A_{driven} is the area enclosed by the driven loop, and Z_{driven} is the total electrical impedance of the driven loop.

Magnetic dipole 106 is operable to receive the drive signal from active electronic component 102 and to produce another field based on the drive signal. In this example, magnetic dipole 106 is a metallic loop connected at its two ends to the output of component 102 for receiving a drive voltage difference. The drive voltage causes the flow of current through the loop for generating another magnetic field or magnetic dipole moment 112. The voltage at the ends of the loop of magnetic dipole 106 can be proportional to the current at the ends of the loop of magnetic dipole 104 by a gain factor of G due to active electronic component 102. Thus, active electronic component 102 can control the relation of the input magnetic field 108 to the output magnetic field 112 such that the output field is a function of the input field.

The provision of an active electronic component in a metamaterial particle as described herein can provide a number of benefits. For example, loss and dispersion can be controlled by controlling the phase delay through the metamaterial particles disclosed herein. Further, for example, a wide bandwidth of responses to sensed fields can be provided.

In another embodiment of the subject matter disclosed herein, a metamaterial particle can include an active electronic component, and field sensing and a field generating elements in the form of electric dipoles. FIG. 2 is a schematic diagram of an exemplary metamaterial particle generally designated 200 including active electronic component 102 and electric dipoles 202 and 204 in accordance with an embodiment of the subject matter disclosed herein. Referring to FIG. 2, electric dipole 202 can function as a field sensing element for sensing an electric field 206. Electric dipole 202 can sense an electric field 204 present in the space of electric dipole 202.

In this example, electric dipole 202 is a wire pair sized smaller than the electric field wavelength. On application of electric field 206 in the space of electric dipole 202, a voltage difference between the wires of the wire pair can be produced that is proportional to the strength of the electric field. The produced voltage difference is referred to herein as a sensed field signal because it is representative of the sensed electric field.

Active electronic component 102 can include an input for receiving the sensed field signal from electric dipole 202. Particularly, active electronic component 102 can receive as input the voltage produced in the wire pair of electric dipole 202. Thus, active electronic component 102 can receive a signal representative of electric field 206. In response to receiving the sensed field signal, active electronic component 102 can produce a drive signal that is a function of the received signal. In this example, active electronic component 102 is an amplifier configured to amplify the sensed field signal by gain G and to output a drive signal, which is the sensed field signal multiplied by gain G. Thus, in this example, the output of the active electronic component is the gain G times the input sensed field signal. Alternatively, the output of the active electronic component can be any predetermined function of the input sensed field signal. Active electronic component 102 can be powered by power source 110.

Electric dipole 204 is operable to receive the drive signal from active electronic component 102 and to produce another field based on the drive signal. In this example, electric dipole 204 is a wire pair connected to component 102 for receiving a drive voltage. The drive voltage can be applied to the wire pair of electric dipole 204 for generating another electric field or electric dipole moment 208. The voltage difference between the wire pair of electric dipole 202 can be proportional to the voltage difference between the wire pair of electric dipole 204 by a gain factor of G due to active electronic component 102. Thus, active electronic component 102 can control the relation of the input electric field 206 to the output electric field 208 such that the output field is a function of the input field.

In yet another embodiment of the subject matter disclosed herein, a metamaterial particle can include an active electronic component, and a field sensing element and a field generating element in the form of a magnetic dipole and an electric dipole, respectively. FIG. 3 is a schematic diagram of an exemplary metamaterial particle generally designated 300 including active electronic component 102, magnetic dipole 104, and electric dipole 204 in accordance with an embodiment of the subject matter disclosed herein. Referring to FIG. 3, magnetic dipole 104 can function as a field sensing element for sensing magnetic field 108, which is propagating through the metallic loop of magnetic dipole 104. On application of magnetic field 108 through the metallic loop, a current is produced in the loop that is proportional to the strength of the magnetic field. The produced current results in a voltage difference at the ends of the loop. The voltage difference is referred to herein as a sensed field signal because it represents the sensed magnetic field and can be received by active electronic component 102.

Active electronic component 102 can include an input for receiving the voltage difference present at the ends of the loop of magnetic dipole 104. The input voltage difference is a signal representative of magnetic field 108. In response to receiving the sensed field signal, active electronic component 102 can produce a drive voltage signal that is a function of the received current signal.

Electric dipole 204 is operable to receive the drive signal from active electronic component 102 and to produce electric field 208 based on the drive signal. Active electronic component 102 can control the relation of the input magnetic field 108 to the output electric field 208 such that the output electric field is a function of the input magnetic field. As a result, metamaterial particle 300 can sense a magnetic field and can generate an electric field as a function of the sensed magnetic field.

In yet another embodiment of the subject matter disclosed herein, a metamaterial particle can include an active electronic component, and a field sensing element and a field generating element in the form of a magnetic dipole and an electric dipole, respectively. FIG. 4 is a schematic diagram of an exemplary metamaterial particle generally designated 400 including active electronic component 102, electric dipole 202, and magnetic dipole 106 in accordance with an embodiment of the subject matter disclosed herein. Referring to FIG. 4, electric dipole 202 can sense electric field 206, which is present in the space of electric dipole 202. On application of electric field 206, a voltage different is produced between the wires of electric dipole 202.

Active electronic component 102 can include an input for receiving the sensed field signal in the form of voltage input from electric dipole 206. The input voltage is a signal representative of electric field 108. In response to receiving the sensed field signal, active electronic component 102 can produce a drive voltage signal that is a function of the received voltage signal.

Magnetic dipole 106 is operable to receive the drive voltage signal from active electronic component 102 and to produce magnetic field 112 based on the drive signal. In particular, active electronic component 102 applies a voltage difference at the ends of the wire loop of magnetic dipole 106 to produce the magnetic field. Active electronic component 102 can control the relation of the input electric field 206 to the output magnetic field 112 such that the output magnetic field is a function of the input electric field. As a result, metamaterial particle 400 can sense an electric field and can generate a magnetic field as a function of the sensed electric field.

The metamaterial particles described herein can be used to as a polarizing element. For example, a metamaterial particle as described herein can be used as a cross-polarizing element. Referring to FIG. 1 for example, the loops of magnetic dipoles 104 and 106 can be oriented in different directions with respect to one another such that the generated magnetic field 106 propagates in a different direction than the sensed magnetic field 108. Similarly, referring to FIG. 2 for example, the wire pairs of electric dipoles 202 and 204 can be oriented in different directions with respect to one another such that the generated electric field 206 propagates in a different direction than the sensed electric field 208. Further, the sensing dipoles can be oriented in different directions for sensing fields oriented in different directions. In addition, the field generating dipoles can be oriented in different directions for generating fields oriented in different directions.

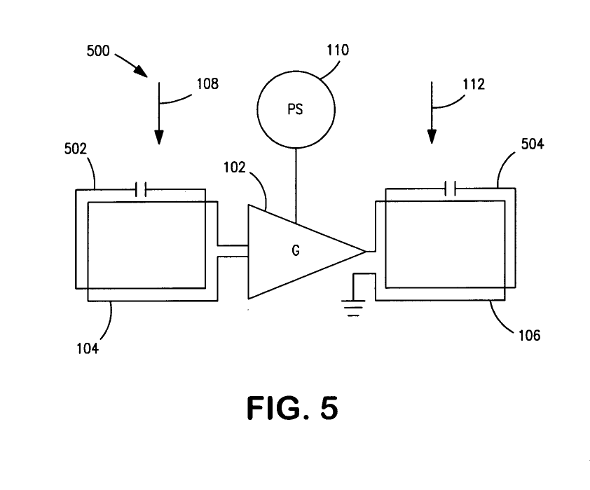

In another embodiment of the subject matter disclosed herein, a metamaterial particle can include an active electronic component, a field sensing element, a field generating element, and elements for resonantly amplifying a sensed field and a produced field. FIG. 5 is a schematic diagram of an exemplary metamaterial particle generally designated 500 including active electronic component 102, magnetic dipoles 104 and 106, and field amplifying elements 502 and 504 in accordance with the subject matter disclosed herein. Referring to FIG. 5, magnetic dipole 104 can sense magnetic field 108. Field amplifying element 502 can be a magnetic loop having ends connected to a capacitor and positioned for resonantly amplifying magnetic field 108. Further, active electronic component 102 can amplify the signal and output an amplified signal at magnetic dipole 106 for producing magnetic field 112. Field amplifying element 504 can be a magnetic loop having ends connected to a capacitor and positioned for resonantly amplifying magnetic field 112. Thus, field amplifying elements 502 and 504 can provide amplification of the magnetic fields for supporting the amplification provided by active electronic component 102.

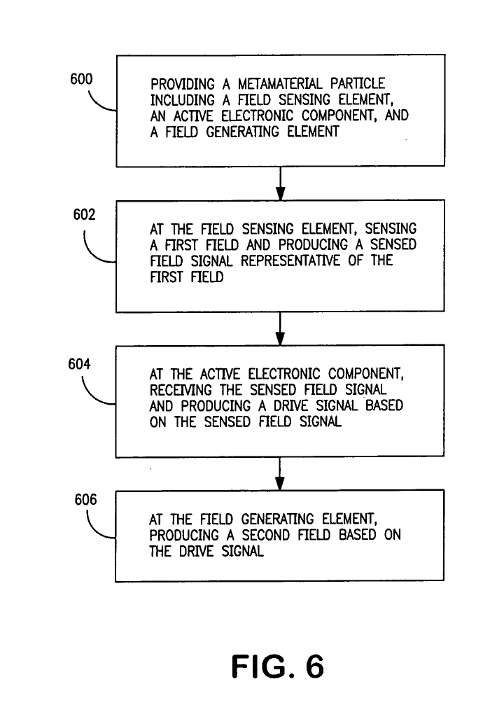

Metamaterial particles as disclosed herein can be utilized in a process for providing a field in response to sensing another field. FIG. 6 is a flow chart illustrating an exemplary process of providing a field in response to sensing another field according to an embodiment of the subject matter disclosed herein. In this example, reference is made to metamaterial particle 100 shown in FIG. 1, although the process may be conducted using any of the exemplary metamaterial particles described herein. Referring to FIG. 6, a metamaterial particle comprising a field sensing element, an active electronic component, and a field generating element is provided (block 600). For example, metamaterial particle 100 shown in FIG. 1 can be provided. At the field sensing element, a first field is sensed, and a sensed field signal representative of the first field is produced (block 602). For example, referring to FIG. 1, the metallic loop of magnetic dipole 104 can sense a magnetic field and a voltage difference representative of the sensed field can be generated in response to the sensed magnetic field.

At block 604, the active electronic component can received the sensed field signal and can produce a drive signal based on the sensed field signal. In FIG. 1 for example, active electronic component 102 can receive the voltage difference from the metallic loop of magnetic dipole 104. Further, active electronic component 102 can generate a drive signal that is an amplification of the received voltage difference signal. The drive signal can be output to the field generating element for producing a second field based on the drive signal (block 606). For example, active electronic component 102 can output the drive signal voltage difference to the metallic loop of magnetic dipole 106 for producing another magnetic field. The active electronic component can thereby generate a field based on another field that has been sensed.

### Mathematical Analysis

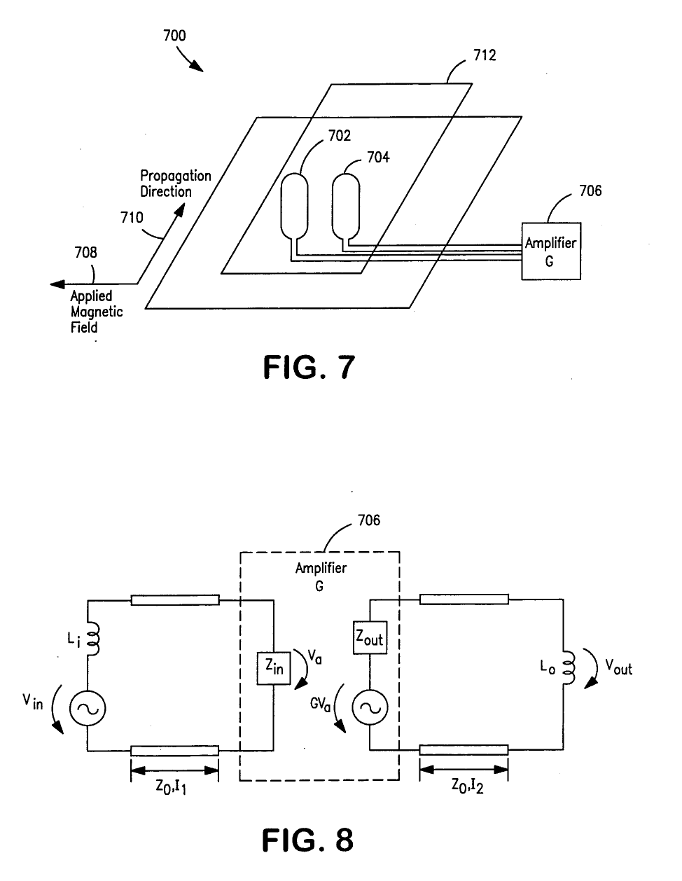

In a mathematical analysis of the subject matter disclosed herein, a plane wave propagating in free space in the direction of a metamaterial particle is considered. In this analysis, reference is made to FIG. 7 where a metamaterial particle generally designated 700 having a field sensing element 702 and a field generating element 704 in accordance with the subject matter disclosed herein is shown. Field sensing element 702 and field generating element 704 are operably connected to an active electronic component (an amplifier in this example) 706 as described in further detail herein. Further, field sensing element 702 and field generating element 704 include metallic loops that are parallel to each other and are both perpendicular to an applied magnetic field (indicated by direction arrow 708) having a propagation direction (indicated by direction arrow 710) towards the field sensing and field generating elements. This arrangement makes the metamaterial particle anisotropic with a non-unity component on the diagonal of the permeability tensor in the direction perpendicular to the loops.

FIG. 8 is a circuit diagram of the magnetic particle shown in FIG. 7. Referring to FIGS. 7 and 8, to control the phase delay through the system, the metallic loops of field sensing element 702 and field generating element 704 are connected to active electronic component 706 through transmission lines of characteristic impedance Z₀ and lengths I₁ and I₂, respectively. Amplifier 706 has input impedance Zᵢₙ, output impedance Zₒᵤₜ, and gain G. The metallic loop of field sensing element 702 has an interior area Aᵢ and inductance L. The voltage picked up by the sensing loop of area Aᵢ and inductance Lᵢ satisfies the following equation (1):

Vᵢₙ=−jωμ₀HAᵢ (1)

where H is the externally applied magnetic field, and the loop is substantially smaller than the wavelength of magnetic field 708. It is noted that in equation (1), the magnetic coupling between the metallic loops is neglected. However, this is justified by the experimental data discussed in the Experimental Results section below. Given these parameters, it can be shown that, assuming no magnetic coupling between the metallic loops, the voltage Vₒᵤₜ across the driven loop of area Aₒ and inductance Lₒ is given by the following equation (2):

$${V}_{out} = {V}_{in} G \frac{{Z}_{0}}{{Z}_{0} + jω {L}_{i}} \cdot \frac{1 + {Γ}_{in}}{{e}^{{jβ}_{1} {l}_{1}} - {Γ}_{in} {Γ}_{in}^{′} {e}^{- {jβ}_{1} {l}_{1}}} \cdot \frac{{Z}_{0}}{{Z}_{0} + {Z}_{out}} \cdot \frac{1 + {Γ}_{in}}{{e}^{{jβ}_{2} {l}_{2}} - {Γ}_{out} {Γ}_{out}^{′} {e}^{- {jβ}_{2} {l}_{2}}} , \qquad ( 2 )$$

where β₁ and β₂ are the propagation constants through the two transmission lines, and where

$$\begin{matrix}{Γ}_{in} = \frac{{Z}_{in} - {Z}_{0}}{{Z}_{in} + {Z}_{0}} ; \\ {Γ}_{in}^{′} = \frac{jω {L}_{i} - {Z}_{0}}{jω {L}_{i} + {Z}_{0}} ; & ( 3 ) \\ {Γ}_{out} = \frac{jω {L}_{0} - {Z}_{0}}{jω {L}_{0} + {Z}_{0}} ; \\ {Γ}_{out}^{′} = \frac{{Z}_{out} - {Z}_{0}}{{Z}_{out} + {Z}_{0}} . & ( 4 )\end{matrix}$$

From these equations, it follows that the currents through the field sensing and field generating loops are iᵢₙ=Vᵢₙ/jωLᵢ (this expression is valid when the inductive impedance is larger than the transformed input impedance) and iₒᵤₜ=Vₒᵤₜ/jωL₀, respectively. Therefore, the magnetic moment generated in metamaterial particle is m=iᵢₙAᵢ+iₒᵤₜA₀, and assuming that the metamaterial particle has volume V_{uc}, it follows that the effective relative permeability of a metamaterial made of arrays of such metamaterial particles is provided by the following equation (5):

$$\begin{matrix}{μ}_{r} = 1 + \frac{m}{{HV}_{uc}} \\ = 1 - \frac{{μ}_{0} {A}_{i}}{{V}_{uc}} ( \frac{{A}_{i}}{{L}_{i}} + \frac{{A}_{0}}{{L}_{0}} {G}_{eff} ) ,\end{matrix} \qquad ( 5 )$$

where G_{eff} is the equivalent gain of the system defined as G_{eff}=νₒᵤₜ/νᵢₙ.

Equations (2)-(5) can be used as design equations for the metamaterial particle shown in FIG. 1. In the following discussion, μᵣ′ and μᵣ″ are the real and imaginary parts of μᵣ. If zero losses are needed in a metamaterial made of such metamaterial particles, μᵣ″ should equal 0, which means, from equation (5), that G_{eff} must be real, or, equivalently, Vₒᵤₜ and Vᵢₙ must be either in phase or 180 degrees out of phase. A closer look at equation (2) reveals that this occurs periodically in frequency because Vₒᵤₜ varies periodically with frequency due to the delay in the transmission lines and the phase distortions of the amplifier. Moreover, if the amplitude |G| is approximately constant with frequency in the band of interest, as it usually happens in practice with most amplifiers, then the amplitude |Vₒᵤₜ| varies slowly with frequency, which means that μᵣ′ oscillates around 1 with minima and maxima at frequencies where, again, Vₒᵤₜ and Vᵢₙ are in phase or 180 degrees out of phase, and where μᵣ″≈0. This feature is demonstrated by experiments described in the following Experimental Results section.

### Experimental Results

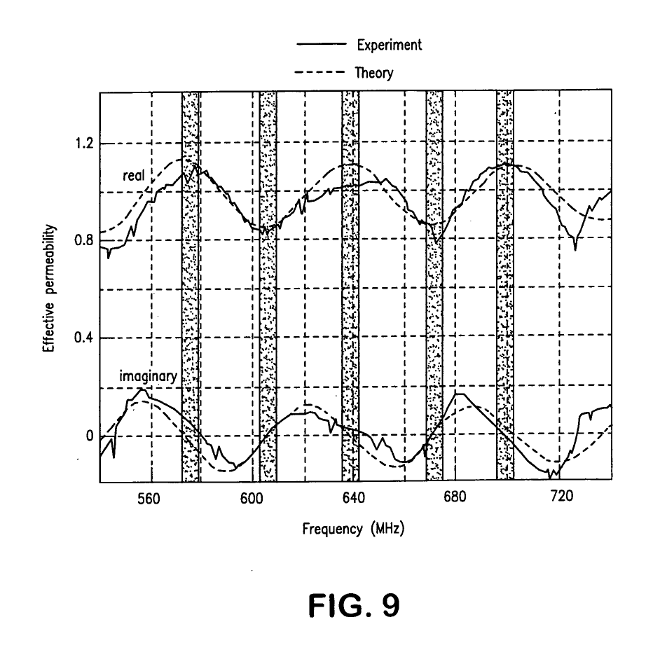

Experiments were conducted using a metamaterial particle having a field sensing element and a field generating element in accordance with the subject matter disclosed herein. In particular, experiments were conducted on a metamaterial particle in accordance with the embodiment shown in FIG. 7. Referring to FIG. 7 for illustrative purposes, a microstrip transmission line was used to excite transverse electromagnetic (TEM) modes to below 900 MHz inside it. Two circular metallic loops 702 and 704 of radius 1.8 cm oriented parallel to each other and the axis of the microstrip are placed inside a waveguide 712. The distance between loops 702 and 704 was 6 cm. Subminiature version A (SMA) cables 1 m long entering the microstrip through two holes drilled through the waveguide walls were used to connect the two loops to an AR 1W1000 microwave amplifier (active electronic component 706) placed outside waveguide 712. The amplifier has a 30±1.5 dB gain between 1 MHz and 1 GHz, 50Ω input and output impedances, has linear phase distortions, and can handle purely inductive loads. Since frequencies below 900 MHz are of interest, the sensing and driven loops are smaller than λ/8, and the effective medium approximation assumed here holds. An AGILENT® 8720A network analyzer (commercially available from Agilent Technologies, Inc., of Santa Clara, Calif.) was used to measure the reflected and transmitted waves through the waveguide. A single field sensing/field generating loop configuration was provided in the experiments so only one metamaterial particle is considered to fill the transverse section of the waveguide. Under these assumptions, the procedure described in the article “Determination of Effective Permittivity and Permeability of Metamaterials From Reflection and Transmission Coefficients,” Smith et al., Phys. Rev., B 65, 195104 (2002), the disclosure of which is incorporated herein by reference in its entirety, was used to retrieve the effective permeability of such a medium. The result is plotted in the solid lines shown in FIG. 9.

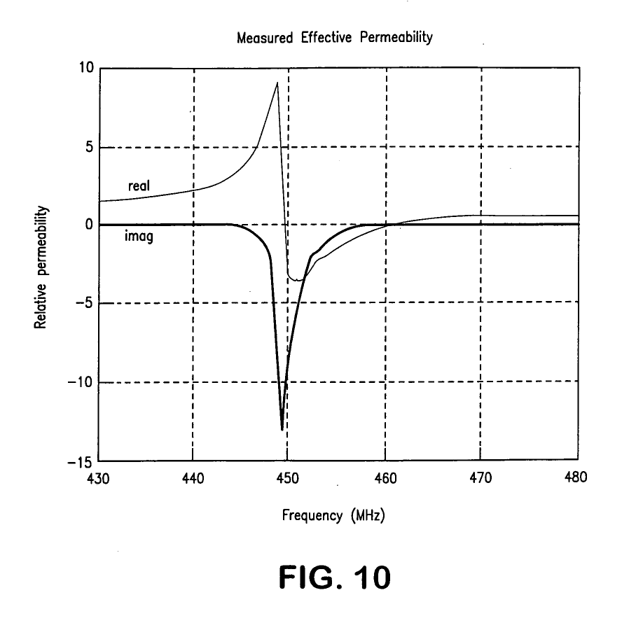

FIG. 9 is a graph showing effective permeability versus frequency for this experiment. The frequencies with almost no dispersion and zero loss are identified by the shadowed regions in FIG. 9. The permeability follows closely the expected theoretical predictions (indicated by dotted lines), which validates equations (1)-(5). Moreover, it is noted that the important features expected theoretically, namely, μᵣ′ oscillates around 1, with maxima and minima occurring at frequencies where μᵣ″ is approximately zero. Thus, for example, at around 602 MHz, the dispersion is almost zero (dμᵣ′/dω≈0) as well as the loss (μᵣ″≈0). Notice that, according to the design equations, in the regions where the amplifier is linear, the response of the active cell is also linear, therefore, the Kramers-Kronig relations must apply. As a result, at the frequencies where there is anomalous dispersion (i.e. dμᵣ′/dω<0)), there must be either loss, or gain, which is in agreement with the retrieved permeability. FIG. 10 is another graph showing measured effective permeability versus frequency in experimental results obtained with a metamaterial particle in accordance with the subject matter disclosed herein.

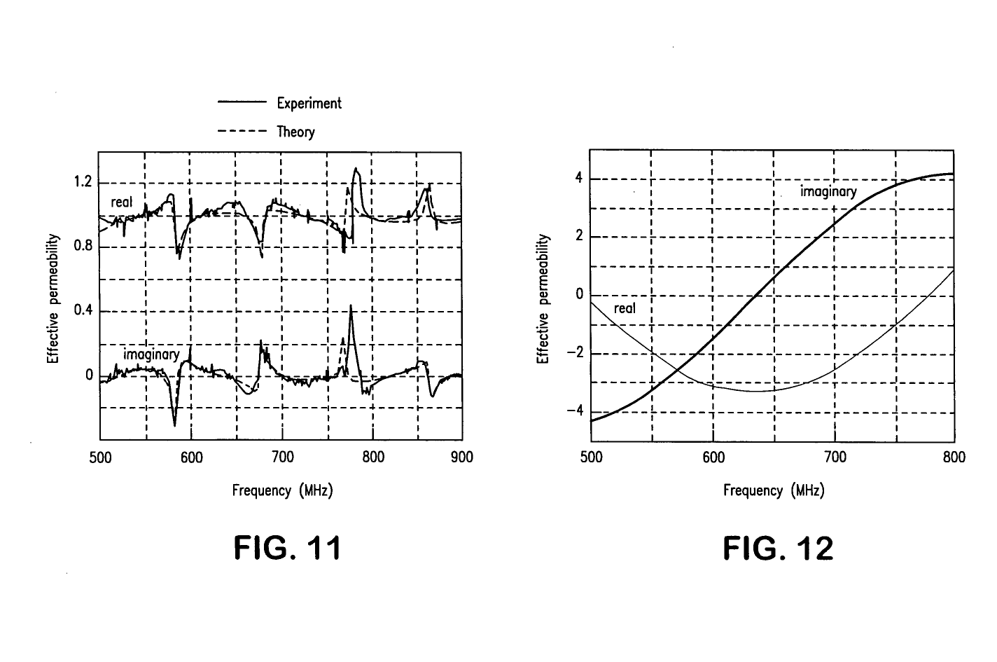

Another experiment was conducted with a different amplifier to ensure a good match between the theoretical and experimentally retrieved permeability is not a coincidence. The AR 1W1000 amplifier was replaced with a MINI-CIRCUITS® ZHL2010 microwave amplifier (commercially available from Scientific Components Corporation, of Brooklyn, N.Y.) in series with a MAXIM® MAX2472 voltage buffer (commercially available from Maxim Integrated Products, Inc., of Sunnyvale, Calif.). Another exemplary amplifier that may be used is the MINI-CIRCUITS® high directivity monolithic amplifier VNA-28 (0.5-2.5 GHz) available from Scientific Components Corporation. The gain of this system was, again, about 30 dB. The output impedance given in the datasheets and measured with the network analyzer was (91−j182) Ω, and was slowly varying with frequency, thus it was approximated as being constant throughout the frequency band of interest. The capacitive component of this impedance together with the inductance of the driven loop was expected to create resonant features in the retrieved permeability. Moreover, these features were expected to be periodic because of the linear phase distortions of the amplifier and buffer, and the length of the cables, as discussed above. Indeed, the experimentally retrieved permeability presented in FIG. 11 clearly shows these features. FIG. 11 is a graph showing effective permeability versus frequency for this experiment. Moreover, the good agreement between the experiment and the theoretical predictions further verify the validity of equations (2)-(5).

These equations facilitate the design of a metamaterial particle that could be used to generate a metamaterial having negative effective permeability. Thus, assuming that the field sensing and field generating loops are kept unchanged, in order to increase the magnetic moment generated in response to an applied magnetic field, it follows from equation (5) that either the concentration of unit cells is increased by decreasing V_{uc}, or increasing Vₒᵤₜ. From equation (2), the latter can be achieved by increasing the amplifier gain, G, its input impedance, Zᵢₙ, or by decreasing the output impedance, Zₒᵤₜ. Thus, assuming a unit cell occupying a volume three times smaller than in the previous experiments, and a miniature amplifier placed inside the cell next to the two loops and having a gain of 40 dB, 200Ω input impedance, 50Ω output impedance, and same linear phase distortions as AR 1W1000, it follows from equation (5) that the relative permeability shown in FIG. 12 can be achieved. It is noted that the oscillatory behavior in this case is caused only by the phase distortions of the amplifier which explains the bigger period. It follows from equations (2) and (5) that the frequency at which zero losses and essentially no dispersion is achieved can be tuned by changing the phase delay through the amplifier (i.e., the phase of G) to bring Vₒᵤₜ and Vᵢₙ in phase at the desired frequency.

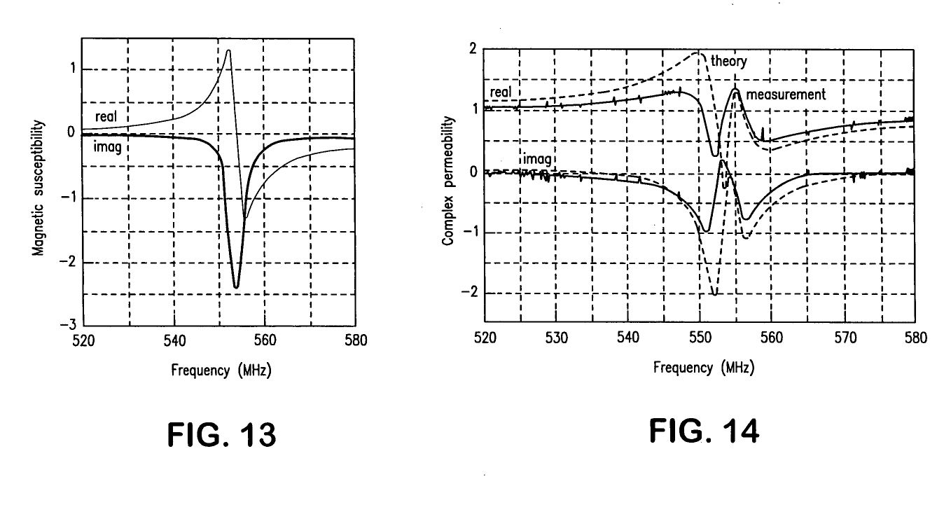

Further, experiments were conducted on metamaterial particles in accordance with the diagram shown in FIG. 5. FIG. 13 is a graph showing the effective magnetic susceptibility of one particle with the power to the amplifier off. The FIG. 13 graph is thus the response of the passive elements of the system and shows the type of material response that can be obtained with passive particles. FIG. 14 is a graph showing the effective magnetic permeability with the power on when the particle acts as an active metamaterial. In FIG. 14, the permeability variation with frequency is completely different, showing that a different class of response can be obtained with active metamaterials. Moreover, the FIG. 14 graph shows that a magnetic permeability much smaller than 1 can be achieved at a frequency where the losses (i.e., the imaginary part of the permeability) is zero. This type of response can be obtained by use of active metamaterials.

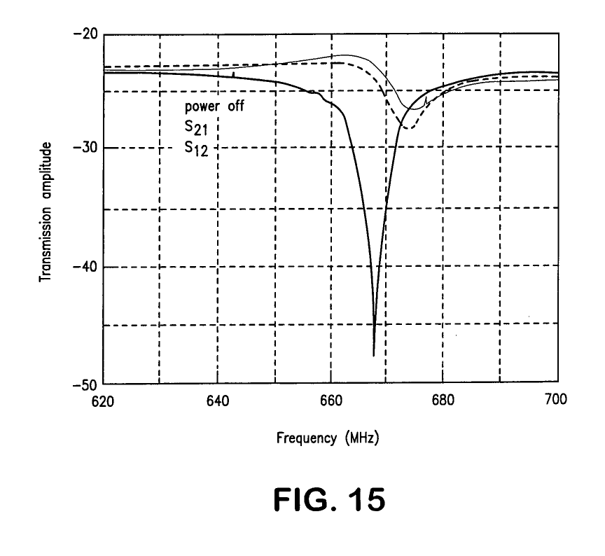

In accordance with the subject matter disclosed herein, an array of metamaterial particles may be arranged together. In one experiment, five identical metamaterial particles, each containing field sensing elements and an active component were arranged in an array. These particular particles contained magnetic field sensing elements and electric field driven elements as shown in FIG. 3. FIG. 15 is a graph showing the transmission amplitude of a signal passing through this array in both directions. The transmitted signal is strongly attenuated and the array is effectively opaque. This demonstrates another way in which active metamaterials can be engineered to have properties different than those that can be obtained with passive metamaterials.

In conclusion, an architecture for active metamaterial particles are disclosed that employ a field sensing element, an active electronic component, and a field generating element that produces the electric or magnetic dipole moment material response. Full design equations for the specific case of an active magnetic metamaterial are disclosed herein that were derived and validated through single metamaterial particle experimental measurements. This active magnetic metamaterial particle exhibits dispersion and loss characteristics that are dramatically different from those found in passive resonant metamaterials, including frequencies where the permeability is less than unity yet with zero loss and near zero dispersion. By controlling the amplifier characteristics, most importantly the phase, a very wide set of metamaterial characteristics can be achieved through this active cell approach.

In one application, numerous metamaterial particles disclosed herein can be embedded in a host matrix for controlling the electromagnetic properties of the material. The metamaterial particles can produce an electric and/or magnetic dipole moment in response to an applied field and, therefore, produce engineered permittivity or permeability, respectively, of the material. The metamaterial particles can be smaller than a wavelength of the applied field.

The subject matter and the experimental results disclosed herein demonstrate a metamaterial particle including an active electronic component and related methods. As described herein, a field sensing element (e.g., a metallic loop to sense a magnetic field, and a wire to sense an electric field) can generate a voltage proportional to a local electric or magnetic field. An active electronic component (e.g. an amplifier), which can be contained inside or outside a metamaterial, amplifies this voltage and controls its phase. The amplifier can driver a field generating element (e.g. a metallic loop to generate a magnetic dipole moment, and a wire to generate an electric dipole moment), which collectively produces an electromagnetic response in the metamaterial. Combinations of different field sensing and field generating elements can enable the production of almost any class of electromagnetic material response, including anisotropic response, off-diagonal response (if the sensing and driven elements are not oriented in the same way), and magnetoelectric response (if the field sensing and field generating elements are of different types).

Because the metamaterial particles described herein are not limited to the specific electromagnetic response of passive components, the metamaterial particles described herein can yield a metamaterial whose properties are essentially constant over a significant band of frequencies. The active electronic component enables the phase difference between the sensed field and the generated field to be controlled, thereby enabling easy design of metamaterials with lossless and strong response or negative response, or metamaterials with significant gain or loss in specific frequency ranges. In contrast, resonator-based passive metamaterials are unavoidably lossy and must have properties that change strongly with frequency (i.e. narrowband). Removing these limitations improves the prospect of functional metamaterial applications significantly.

Further, hybrid active-passive metamaterials can be provided in accordance with the subject matter disclosed herein. Such hybrid metamaterials can include both active and passive components. Passive metamaterials can generate a strong material response very efficiently, but they can be very lossy. This loss can be offset by embedding active elements along with resonant passive elements. Modest power is needed to produce a net magnetic or electric dipole moment to cancel the phase-quadrature response of the passive element without significantly modifying its in-phase response (which is responsible for the real part of the effective permittivity or permeability). Such a hybrid metamaterial can be lossless and also suitable for applications not possible with passive, lossy metamaterials.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A metamaterial particle comprising:
(a) a field sensing element adapted to sense a first field and adapted to produce a sensed field signal representative of the first field in response to sensing the first field;
(b) an active electronic component adapted to receive the sensed field signal and adapted to produce a drive signal based on the sensed field signal; and
(c) a field generating element adapted to receive the drive signal and adapted to produce a second field based on the drive signal.

2. The metamaterial particle of claim 1 wherein the field sensing element comprises a magnetic dipole, and wherein the first field comprises a magnetic field, the sensed field signal being representative of the magnetic field.

3. The metamaterial particle of claim 2 wherein the magnetic dipole is adapted to produce a current in response to sensing the magnetic field, the current being proportional to the magnetic field.

4. The metamaterial particle of claim 3 wherein the magnetic dipole comprises a metallic loop.

5. The metamaterial particle of claim 1 wherein the field sensing element comprises an electric dipole, and wherein the first field comprises an electric field, the sensed field signal being representative of the electric field.

6. The metamaterial particle of claim 5 wherein the electric dipole comprises a wire.

7. The metamaterial particle of claim 1 wherein the active electronic component comprises an amplifier adapted to amplify the sensed field signal by a predetermined gain, the drive signal being produced by the amplification of the sensed field signal by the predetermined gain.

8. The metamaterial particle of claim 1 wherein the active electronic component is adapted to control a phase delay between the sensed field signal and the drive signal.

9. The metamaterial particle of claim 1 wherein the field generating element comprises a magnetic dipole adapted to produce a magnetic dipole moment in response to the drive signal.

10. The metamaterial particle of claim 9 wherein the magnetic dipole comprises a metallic loop.

11. The metamaterial particle of claim 1 wherein the field generating element comprises an electric dipole adapted to produce an electric dipole moment in response to the drive signal.

12. The metamaterial particle of claim 11 wherein the electric dipole comprises a wire.

13. The metamaterial particle of claim 1 wherein the field sensing element and the field generating element comprise first and second magnetic dipoles, respectively, and wherein the first and second fields comprise first and second magnetic fields, respectively.

14. The metamaterial particle of claim 1 wherein the field sensing element and the field generating element comprise first and second electric dipoles, respectively; and wherein the first and second fields comprise first and second electric fields, respectively.

15. The metamaterial particle of claim 1 wherein the field sensing element comprises an electric dipole, wherein the field generating element comprises a magnetic dipole, wherein the first field comprises an electric field, and wherein the second field comprises a magnetic field.

16. The metamaterial particle of claim 1 wherein the field sensing element comprises a magnetic dipole, wherein the field generating element comprises an electric dipole, wherein the first field comprises a magnetic field, and wherein the second field comprises an electric field.

17. The metamaterial particle of claim 1 comprising a power source adapted to provide power to the active electronic component.

18. The metamaterial particle of claim 1 comprising a field amplifying element adapted to resonantly amplify the sensed first field.

19. The metamaterial particle of claim 1 comprising a field amplifying element adapted to resonantly amplify the produced second field.

20. A method of providing a field in response to sensing another field, the method comprising:
(a) providing a metamaterial particle comprising a field sensing element, an active electronic component, and a field generating element;
(b) at the field sensing element, sensing a first field and producing a sensed field signal representative of the first field;
(c) at the active electronic component, receiving the sensed field signal and producing a drive signal based on the sensed field signal; and
(d) at the field generating element, producing a second field based on the drive signal.

21. The method of claim 20 wherein the field sensing element comprises a magnetic dipole, and wherein the first field comprises a magnetic field, the sensed field signal being representative of the magnetic field.

22. The method of claim 21 wherein producing a sensed field signal comprises producing, at the magnetic dipole, a current in response to sensing the magnetic field, the current being proportional to the magnetic field.

23. The method of claim 22 wherein the magnetic dipole comprises a metallic loop.

24. The method of claim 20 wherein the field sensing element comprises an electric dipole, and wherein the first field comprises an electric field, the sensed field signal being representative of the electric field.

25. The method of claim 24 wherein the electric dipole comprises a wire.

26. The method of claim 20 wherein the active electronic component comprises an amplifier, and wherein producing a drive signal comprises amplifying, at the amplifier, the sensed field signal by a predetermined gain, the drive signal being produced by the amplification of the sensed field signal by the predetermined gain.

27. The method of claim 20 comprising controlling, at the active electronic component, a phase delay between the sensed field signal and the drive signal.

28. The method of claim 20 wherein the field generating element comprises a magnetic dipole, and wherein producing a second field comprises producing, at the magnetic dipole, a magnetic dipole moment in response to the drive signal.

29. The method of claim 28 wherein the magnetic dipole comprises a metallic loop.

30. The method of claim 20 wherein the field generating element comprises an electric dipole, and wherein producing a second field comprises producing, at the electric dipole, an electric dipole moment in response to the drive signal.

31. The method of claim 30 wherein the electric dipole comprises a wire.

32. The method of claim 20 wherein the field sensing element and the field generating element comprise first and second magnetic dipoles, respectively, and wherein the first and second fields comprise first and second magnetic fields, respectively.

33. The method of claim 20 wherein the field sensing element and the field generating element comprise first and second electric dipoles, respectively, and wherein the first and second fields comprise first and second electric fields, respectively.

34. The method of claim 20 wherein the field sensing element comprises an electric dipole, wherein the field generating element comprises a magnetic dipole, wherein the first field comprises an electric field, and wherein the second field comprises a magnetic field.

35. The method of claim 20 wherein the field sensing element comprises a magnetic dipole, wherein the field generating element comprises an electric dipole, wherein the first field comprises a magnetic field, and wherein the second field comprises an electric field.

36. The method of claim 20 comprising providing a power source, and wherein the method comprises providing, at the power source, power to the active electronic component.

37. The method of claim 20 comprising:
providing a field amplifying element; and
amplifying the sensed first field with the field amplifying element.

38. The method of claim 20 comprising:
providing a field amplifying element; and
amplifying the produced second field with the field amplifying element.
